(19) United States
(12) Patent Application Publication
(10) Pub. No.: US 2015/0145325 A1
(43) Pub. Date: May 28, 2015

(54) ACTIVE POWER FACTOR CORRECTION FOR AIRCRAFT POWER SYSTEM HARMONIC MITIGATION

(71) Applicant: Eaton Corporation, Cleveland, OH (US)

(72) Inventors: Sayeed Ahmad Mir, Saginaw, MI (US); John Neely, Kentwood, WA (US); Stanley Seely, Kentwood, MI (US); Derek Dougherty, Muskegon, MI (US); Andrew Thompson, Ada, MI (US); Peter Torres, Plainwell, MI (US); James Broadwell, Grand Rapids, MI (US); Thomas Blair, Grand Rapids, MI (US)

(21) Appl. No.: 14/409,629

(22) PCT Filed: Mar. 15, 2013
(86) PCT No.: PCT/US2013/032380

§ 371 Date: Dec. 19, 2014

Related U.S. Application Data
(60) Provisional application No. 61/663,288, filed on Jun. 22, 2012.

(51) Int. Cl. H02M 1/42; H02M 7/04; H02J 5/00; H02M 1/12

(52) U.S. Cl. CPC H02M 1/4225; H02M 1/12; H02M 1/4216; H02M 7/04; H02J 5/00
USPC 307/9.1; 363/44

(57) ABSTRACT

Active power factor correction can be used to reduce input harmonics in an aircraft power distribution system. In an embodiment, one or more power factor correction (PFC) units can be placed in a power distribution system to profile an input signal. Each PFC unit can include a converter, such as an AC-DC converter, and can be placed in the power system bus on the input side of the load. In an embodiment, a PFC unit can include a boost rectifier topology with active power factor correction for harmonics elimination.

### CROSS-REFERENCE TO RELATED APPLICATIONS

This application is a national stage filing based upon International Application No. PCT/US2013/032380, with an international filing date of Mar. 15, 2013, which claims the benefit of U.S. Provisional Application Ser. No. 61/663,288, filed Jun. 22, 2012, the entire disclosures of which are incorporated herein by reference.

### BACKGROUND

1. Technical Field

The present disclosure relates generally to aircraft power distribution systems, including active power factor correction within power distribution systems.

2. Description of the Related Art

In general, the aircraft industry is trending towards developing more electric aircraft (MEA) by replacing hydraulic and pneumatic actuation systems with electric actuation systems, thus increasing the demands on the electrical generation and distribution systems of the aircraft. For example, system stresses such as transient loads, reactive loads, other nonlinear loads, and current harmonics must increasingly be accounted for to ensure proper operation of all electrical components. Furthermore, the aircraft industry is also trending away from frequency-regulated power generators and towards variable frequency (a.k.a. wild frequency) generators. The input source voltage from such wild frequency generators can vary within a range of, for example, 350 to 800 Hz, leading to increased power loss in transformers at higher frequencies and saturation effects at lower frequencies.

Transient loads (i.e., loads that operate for a short duration) increase the peak power demand of the aircraft power system over the average power demand of the system. Very high transient loads can also make the power system unstable if the aircraft power generator is too slow to respond to the rapid changes from these loads. Properly sizing the power generator and power distribution system for peak demands of transient loads can result in a heavy and costly system.

Reactive loads include capacitive and inductive loads that are directly connected to the aircraft power bus. Such reactive loads can add or subtract reactive power into/from the power system, thus increasing the maximum output capacity (i.e., KVA rating) required for the power generation and distribution system. Current harmonics caused by, for example, AC-AC power conversion, can create dielectric stress, overheat cables and transformers, trip protection devices, and under extreme conditions, create voltage instability. Conventional systems may not adequately account for, among other things, input current harmonics.

FIG. 1 is a block diagram view of an embodiment of a conventional power distribution system 10. The conventional system 10 can include an alternating-current (AC) power supply 12, a 3-phase rectifier 14, a DC link capacitor 16, an inverter 18, a motor 20, and a mechanical load 22. In tandem, the rectifier 14 and inverter 18 may act as an AC-AC converter to provide the appropriate input waveform for the motor 20, which is coupled to the mechanical load 22. The mechanical load 22 can be, for example only, an aircraft actuator, such as an actuator for a flight control surface.

The AC-AC conversion by the rectifier 14 and inverter 18 can inject significant current harmonics on the AC power input, and accordingly on the input to other components that may draw power from the AC power supply 12. FIGS. 2A-2B are plots illustrating an input voltage 24, input current 26, and input harmonics that may be induced on the AC power bus. As shown, the voltage 24 and current 26 may be out-of-phase with each other, and the fifth (5^{th}) harmonic 28, seventh (7^{th}) harmonic 30, and higher odd harmonics may have significant amplitudes. As noted above, such harmonics can adversely affect the components on the power distribution system.

In some other conventional aircraft power distribution systems, high voltage DC is produced by Transformer Rectifier Units (TRU) or Autotransformer Rectifier Units (ATRU) on the output of a fixed or variable frequency generator. The TRU or ATRU can be very heavy and expensive. As nonlinear loads increase, the harmonics injected on the input significantly increases the weight added by the TRU or ATRU units and makes it difficult to meet power density targets.

### SUMMARY

The present disclosure includes a technology and architecture to address one or more power quality issues in aircraft, such as more electric aircraft (MEA), for example.

One solution for one or more of the above-noted deficiencies in conventional power distribution systems is active power factor correction. In an embodiment of active power factor correction, a power factor correction unit may comprise an alternating current (AC) input, configured to receive AC electricity and a rectifier having an input electrically coupled with the AC input and providing a direct current (DC) output. The power factor correction unit may further comprise a power converter having an input electrically coupled with the DC output of the rectifier, and a power factor control circuit configured to control the power factor of the power factor correction unit, the power factor control circuit configured to output a control signal for the power converter, the control signal produced according to a harmonic of the DC output of the rectifier.

A power distribution system for an aircraft may include an alternating current (AC) input, configured to receive AC electricity and two or more power factor correction units. Each power factor correction unit may include a rectifier having an input electrically coupled with the AC input and providing a direct current (DC) output, a power converter having an input electrically coupled with the DC output of the rectifier, and a power factor control circuit configured to control the power factor of said power factor correction unit, the power factor control circuit configured to output a control signal for the power converter, the control signal produced according to a harmonic of the DC output of the rectifier. The two or more power factor correction units may be collectively configured to provide a collective DC output.

A method of distributing power may include receiving an alternating current (AC) input, converting the AC input to a direct current (DC) signal with a rectifier, creating a DC output according to the DC signal with a power converter, and controlling the power converter with a power factor control circuit according to a harmonic of the DC signal.

### BRIEF DESCRIPTION OF THE DRAWINGS

Embodiments of the invention will now be described, by way of example, with reference to the accompanying drawings, wherein:

FIG. 1 is a block diagram view of a conventional power distribution system.

FIGS. 2A-2B are plots illustrating an exemplary input power voltage, input current, and input harmonic content of the power converter of FIG. 1.

FIG. 3 is a block diagram of an embodiment of an aircraft power distribution system according to aspects of the present disclosure.

FIG. 4 is a schematic and block diagram of an embodiment of a power factor correction (PFC) unit that may find use in connection with a system such as shown in FIG. 3.

FIG. 5 is a plot illustrating exemplary output power characteristics of a portion of a PFC unit.

FIG. 6 is a block diagram illustrating an exemplary power factor correction algorithm that may be applied by a PFC unit.

FIG. 7 is a block diagram illustrating an embodiment of a voltage vector sub-function of a power factor correction algorithm of the type shown in FIG. 6.

FIG. 8 is a schematic view of a virtual ground that may be employed with a voltage vector sub-function such as illustrated in FIG. 7.

FIG. 9 is a block diagram illustrating an exemplary embodiment of a 6^{th} harmonic sub-function of a power factor correction algorithm such as illustrated in FIG. 6.

FIG. 10 is a block diagram illustrating an embodiment of a current limit sub-function of the power factor correction algorithm such as illustrated in FIG. 6.

FIGS. 11A-11B are plots illustrating an input power voltage, current, and harmonic content of a power converter incorporating power factor correction functionality.

FIG. 12 is a schematic view of an embodiment of a modular distributed power factor correction unit architecture.

FIG. 13 is a block diagram illustrating an embodiment of a current-sharing algorithm for the modular distributed power factor correction unit of FIG. 12.

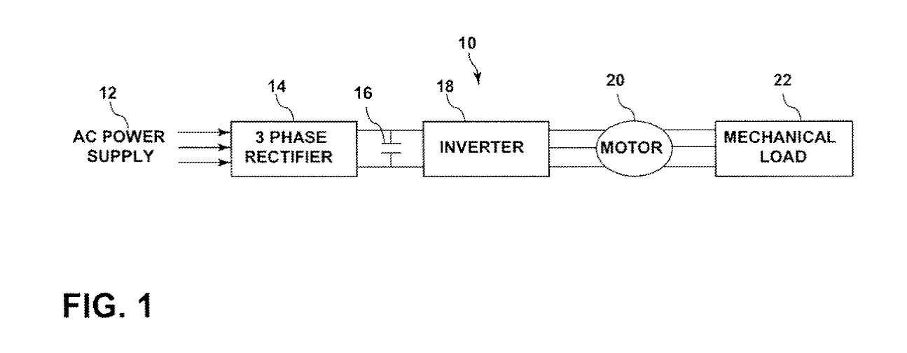

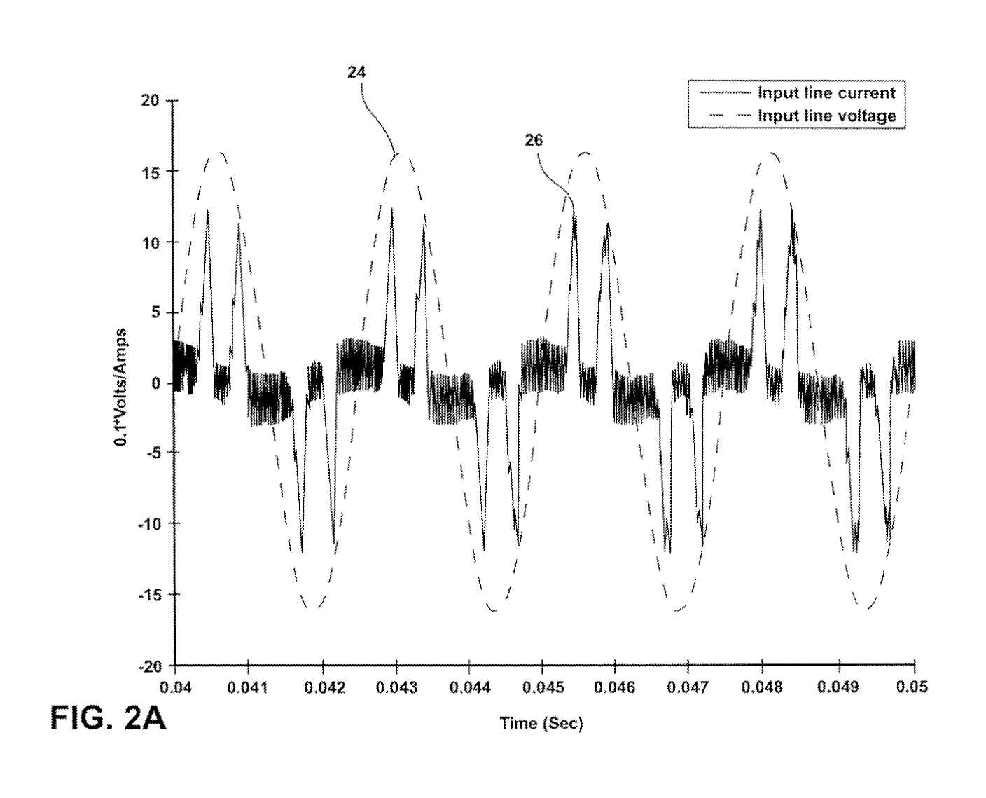

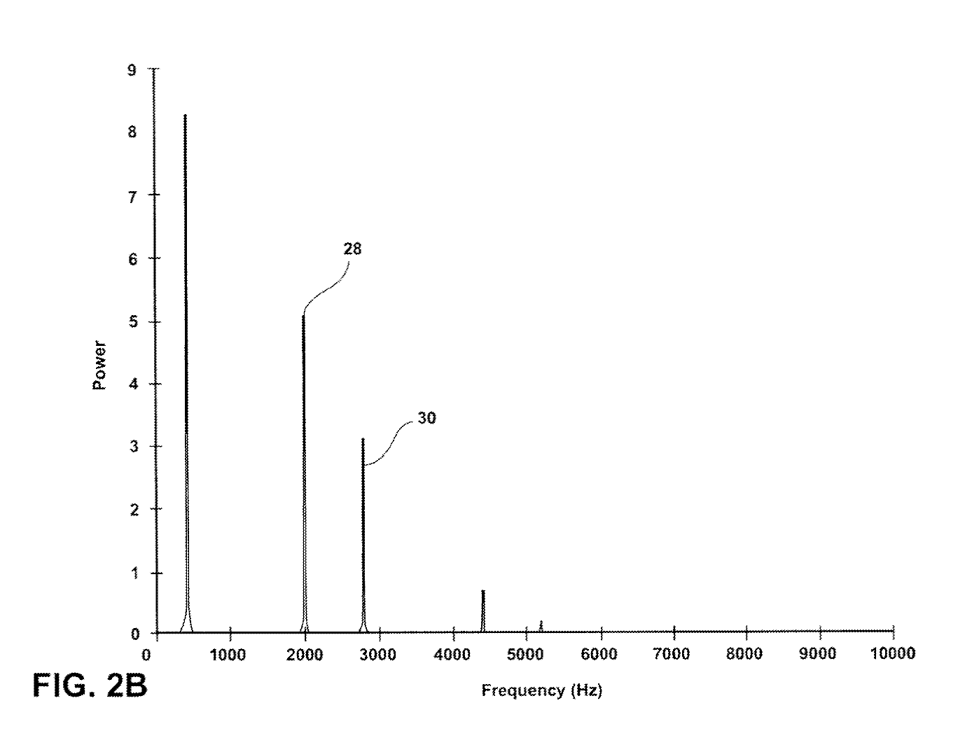

### DETAILED DESCRIPTION

Reference will now be made in detail to embodiments of the present disclosure, examples of which are described herein and illustrated in the accompanying drawings. While the invention will be described in conjunction with embodiments, it will be understood that they are not intended to limit the invention to these embodiments. On the contrary, the invention is intended to cover alternatives, modifications and equivalents, which may be included within the spirit and scope of the invention as defined by the appended claims.

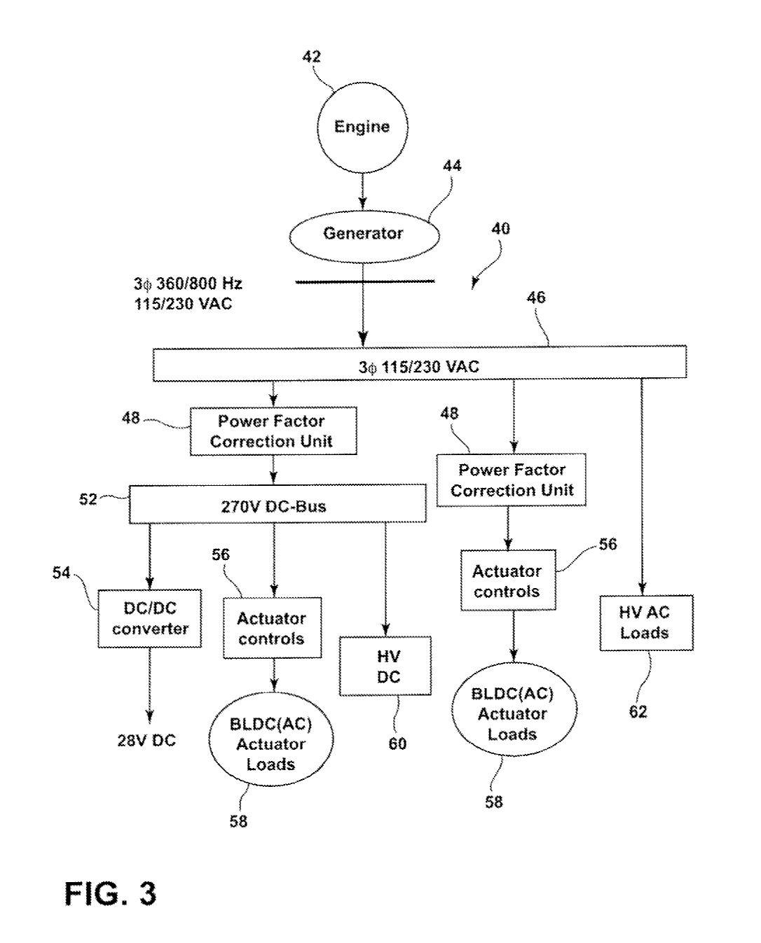

FIG. 3 is a block diagram of an embodiment of an aircraft power distribution system 40 shown coupled to an engine 42 and a power generator 44. The power generator 44 can be, for example only and without limitation, a wild frequency generator. The power distribution system 40 can include a three-phase AC power bus 46, two power factor correction (PFC) units 48, a DC power bus 52, a DC-DC converter 54, a number of actuator controls 56, a number of brushless DC (BLDC) and AC (BLAC) actuator loads 58, high voltage DC (HVDC) loads 60, and high voltage AC (HVAC) loads 62. Generally, excepting PFC units 48, many components of the system 40 may comprise conventional components known in the art.

With embodiments, the PFC units 48 can be provided or located in the aircraft power distribution system 40 at the input of one or more AC-DC converters to reduce the harmonics on the AC power bus that may be induced by the AC-DC power conversion. In embodiments, PFC units 48 can combine power conversion (i.e., AC-DC, DC-DC, or AC-AC) and power factor correction in a single circuit or apparatus.

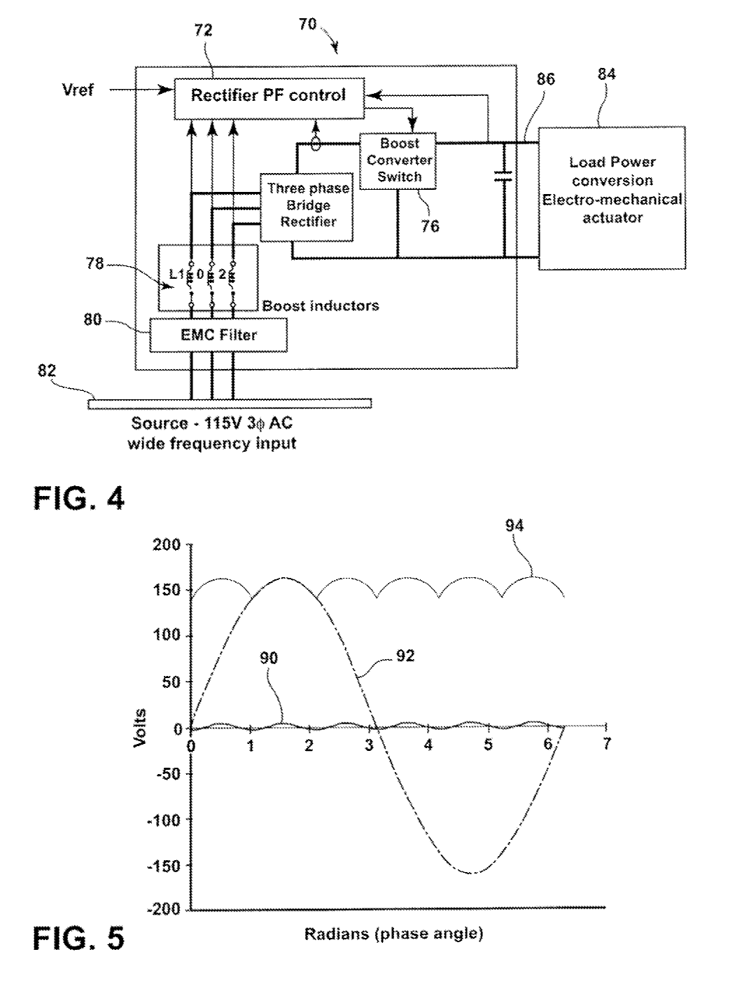

FIG. 4 is a schematic and block diagram illustrating an exemplary embodiment of a PFC unit, illustrated generally in the form of a boost rectifier 70. As shown in the illustrated embodiment, the boost rectifier 70 may include a power factor correction control circuit 72, a three-phase AC-DC bridge rectifier 74, a boost converter switch 76, a plurality of boost inductors 78, and an electromagnetic compatibility (EMC) filter 80. The boost converter switch 76 can be a portion of a DC-DC boost converter.

The bridge rectifier 74 may be coupled, at its input, to an AC voltage source 82 and a reference voltage V_{ref} and, at its output, to an electromechanical or other actuator or other load and, if the actuator requires AC power, to a DC-AC power converter, all of which output is represented by block 84, via a DC link 86. Accordingly, the bridge rectifier 74 may be configured to receive an AC input signal and output a DC signal. The PFC unit is not limited to a particular type of AC-DC conversion. The bridge rectifier 74 is exemplary only, the PFC unit may include any known AC-DC conversion device or system.

The boost converter of which the boost converter switch 76 may form a part is provided as an exemplary DC-DC power converter. The boost converter may be configured to receive an input DC signal and output a DC signal of a different voltage. The boost converter may operate according to a signal input to the boost converter switch 76.

The PFC control circuit 72 may be configured to receive input from sensors electrically coupled with the output of the bridge rectifier 74. From each of the sensors, the PFC control circuit may receive an AC input. The PFC control circuit may also receive a desired DC voltage V_{ref}. According to the received AC signals and V_{ref}, the PFC control circuit 72 may control the boost converter. Through its control of the boost converter, the PFC control circuit may perform or address several functions, including those described below.

First, the PFC control circuit 72 can regulate the voltage on the DC link 86 at a boosted level (e.g., 25% or more) above a nominal rectified DC link voltage (i.e., where the nominal voltage is determined according to the AC signal input to the PFC unit.

Second, the PFC control circuit 72 may regulate the voltage at the output of each of the boost inductors 78, which may allow the input current to be profiled as a sinusoid. The PFC control circuit 72 can also be configured to control the boost converter switch 76 to operate the boost converter in a discontinuous conduction mode. In embodiments, as an effect of controlling the boost converter in a discontinuous conduction mode, the average values of the input waveforms in a switching cycle of the boost converter may be proportional to instantaneous values of corresponding phase voltages. Thus, for example, in embodiments input phase currents may track the input voltages, and a near-unity power factor may be obtained.

Third, the PFC control circuit 72 may regulate an output voltage of the rectifier 74. However, regulating the output voltage of a rectifier 74 may also affect the input waveform. For example, an embodiment of a three-phase rectifier may naturally produce a 6^{th} order harmonic on its output signal due to the conduction of each of the six diodes included in the rectifier 74. In embodiments, a rectifier may produce harmonics of 3^{rd}, 4^{th}, 5^{th}, 6^{th}, 7^{th}, or any order. The discussion above and below is with respect to an embodiment in which a 6^{th} order harmonic may be naturally produced by the rectifier 74, as discussed above. It should be understood, however, that the systems, devices, and methods disclosed herein are not limited to such a rectifier embodiment. Regulating the voltage at the output of the rectifier 74 may cause the 6^{th} order harmonic to instead appear in the input phase currents. To reduce input harmonic effects, a PFC control circuit 72 can inject the 6^{th} harmonic content on the output of the boost rectifier 70 through control of the boost converter. FIG. 5 is a plot generally illustrating an exemplary 6^{th} harmonic waveform 90 that may be injected given a particular input phase 92 and a particular DC output voltage 94 of a boost rectifier 70. To perform such above functions, the PFC control circuit 72 can be configured to execute one or more algorithms or functions, including those discussed below.

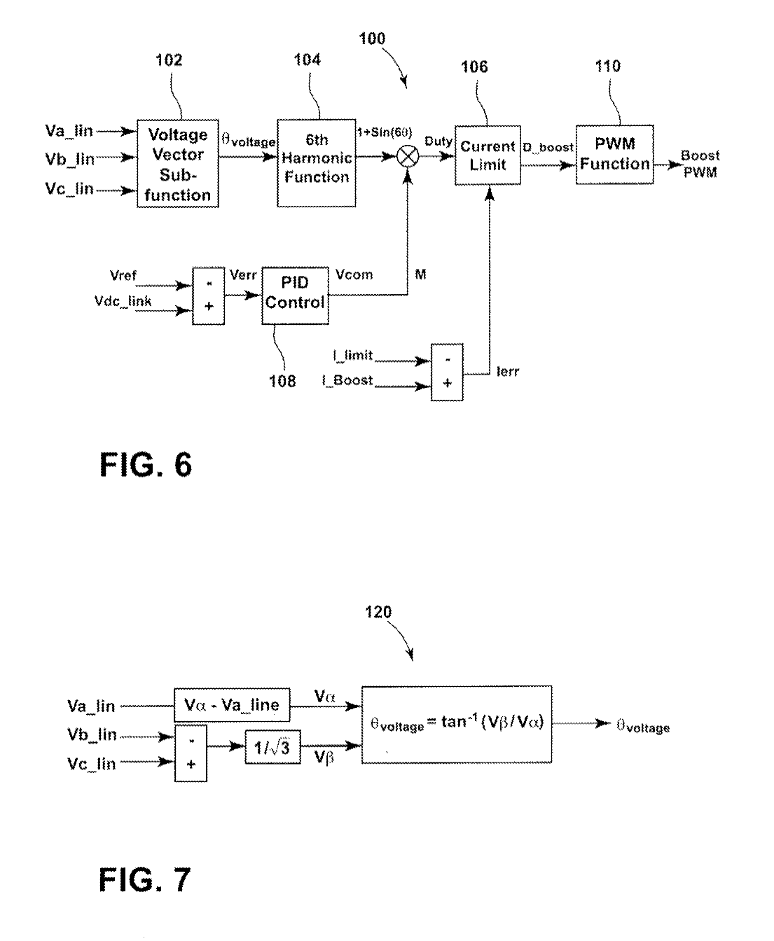

FIG. 6 is a block diagram generally illustrating an embodiment of a control algorithm 100 that may be applied by a power factor correction unit or a portion thereof (such as the PFC control circuit 72) for reducing or eliminating input harmonics. A power factor correction algorithm 100 can be configured to include or provide one or more sub-functions—a voltage vector sub-function 102, a 6^{th} harmonic sub-function 104, a current limit sub-function 106, a voltage proportional-integral-derivative (PID) sub-function 108, and/or a pulse-width modulation (PWM) control sub-function 110. By performing sub-functions and operations such as those illustrated and described herein, a power factor correction unit may effectively reduce harmonics on the input current supplied by a power distribution system. While an algorithm is generally described herein with reference to a boost rectifier 70, it should be understood that the algorithm may find use with various other circuits and devices employing a power factor correction unit or control circuit.

Embodiments of a control algorithm 100 can include or use a number of variables and measurements. For example, a DC bus voltage V_{dc}_{_{—}}ₗᵢₙₖ can be measured using a differential voltage sensor. A desired DC bus voltage V_{ref} (which may command the desired voltage at the DC bus V_{dc}_{_{—}}ₗᵢₙₖ) can be selected for the needs of the particular application. In an embodiment, V_{ref} may be set at more than 25% above the nominal DC voltage (i.e., as determined according to the input AC signal) without boost. For example, for an exemplary 115 V input AC system, the nominal DC output voltage may be around 270 V, and the boost voltage may be set at about 350 V or more for satisfactory current regulation. V_{ref} can be compared to V_{dc}_{_{—}}ₗᵢₙₖ to determine voltage error Vₑᵣᵣ, which can be fed into a PID controller (e.g., executing a PID sub-function 108) to develop V_{com}, which is the duty cycle for the power factor correction (PFC) control. Vcom can be multiplied by output of the 6^{th} harmonic function 104, 1+sin(6*θ_{voltage}), to generate a duty variable, which is input to the current limit sub-function 106. Another input to the current limit sub-function 106 can be Iₑᵣᵣ and can be generated by comparing the output current of the boost converter Iboost with a current limit Iₗᵢₘᵢₜ, which can be selected to limit the current through the boost switch within the safe operating range of the circuit. The gain of the PID control sub-function 108 can be tuned to achieve an optimum response over a large load range while also minimizing harmonic content at the input.

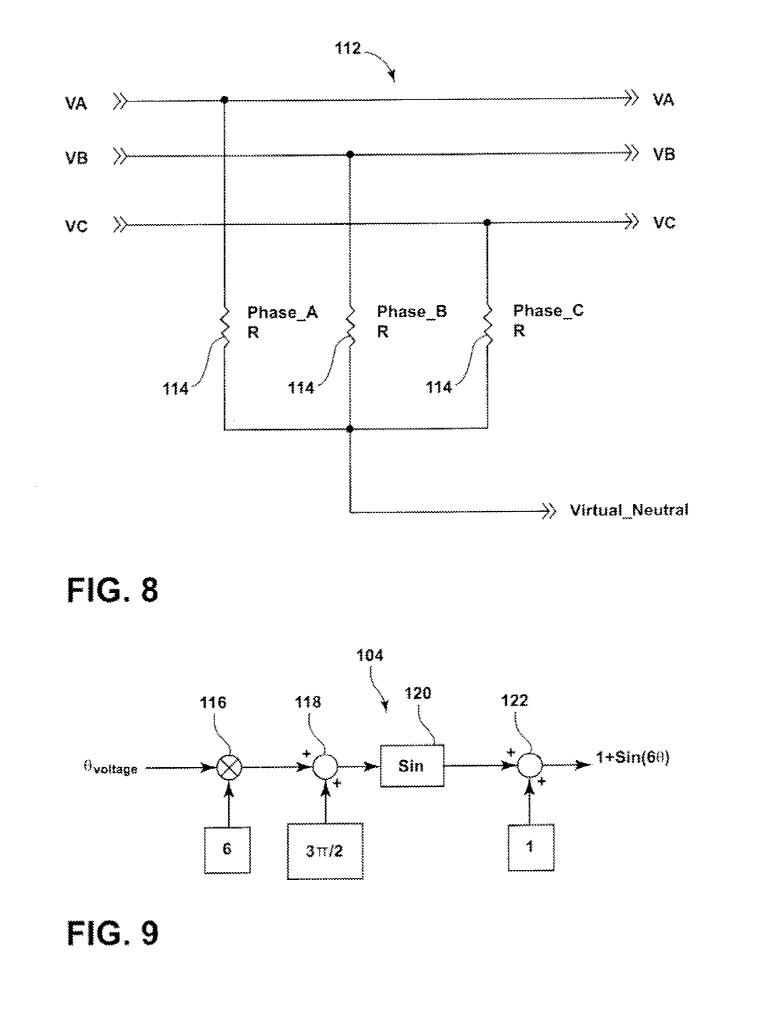

FIG. 7 is a block diagram illustrating an embodiment of a voltage vector sub-function 102. In the illustrated embodiment, the voltage vector sub-function 102 may be used to calculate an input voltage phase (θ_{voltage}). Three differential voltage sensors Vₐ_{_{—}}ₗᵢₙ, V_{b}_{_{—}}ₗᵢₙ, and V_{c}_{_{—}}ₗᵢₙ can be used to measure the input AC voltage of three input lines. In an embodiment, Vₐ_{_{—}}ₗᵢₙ, V_{b}_{_{—}}ₗᵢₙ, and V_{c}_{_{—}}ₗᵢₙ may be electrically coupled to the respective outputs of the boost inductors 78 for this purpose. As illustrated, a variable V_{α} may be set equal to Vₐ_{_{—}}ₗᵢₙ. A second variable V_{β} may be equal to (V_{c}_{_{—}}ₗᵢₙ−V_{b}_{_{—}}ₗᵢₙ)/sqrt (3). The input voltage phase may thus equal the inverse tangent of V_{β}/V_{α}. A virtual ground 112 as shown in FIG. 8, can be created using three high-impedance resistors 114 and can be used for measuring Vₐ_{_{—}}ₗᵢₙ, V_{b}_{_{—}}ₗᵢₙ, and V_{c}_{_{—}}ₗᵢₙ.

FIG. 9 is a block diagram of an exemplary embodiment of a 6^{th} harmonic sub-function 104. As noted above, some 6^{th} order harmonic information may be lost from the rectifier output due to power factor control. More specifically, 6^{th} harmonic information must generally be accounted for due to lag from the sampling time of the input current. In embodiments, harmonic information other than a 6^{th} order may be lost or otherwise need to be accounted for. Accordingly, a correction angle may be added to θ_{voltage} to address or overcome this effect. The 6^{th} harmonic sub-function 104 may provide such a correction angle. The 6^{th} harmonic sub-function 104 may be used to calculate the phase angle of a 6^{th} harmonic of the output for a rectifier 74. The input phase angle, θ_{voltage}, may be multiplied by 6 at a multiplication block 116 and shifted by 3π/2 radians at a shift block 118 to produce a modified 6^{th} order phase angle. This modified phase angle can be passed through a sine function at a sine function block 120 and added to a unity at an addition block 122 to generate an output signal of the form 1+sin(6*θ_{voltage}).

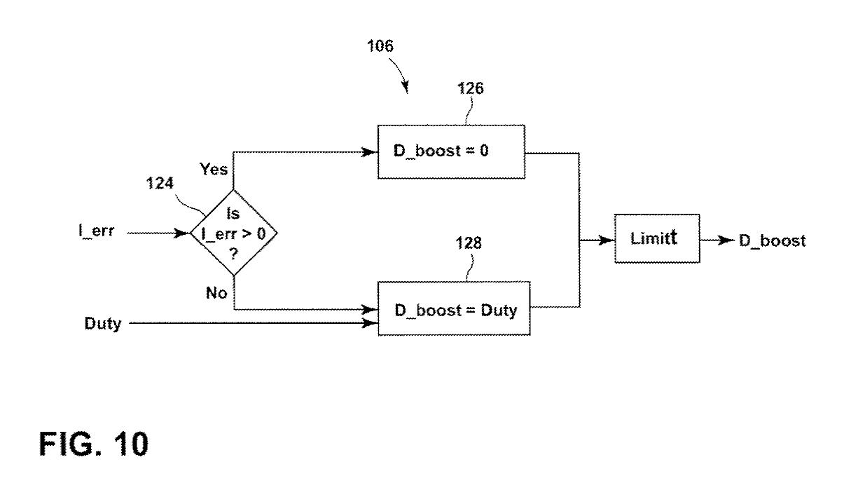

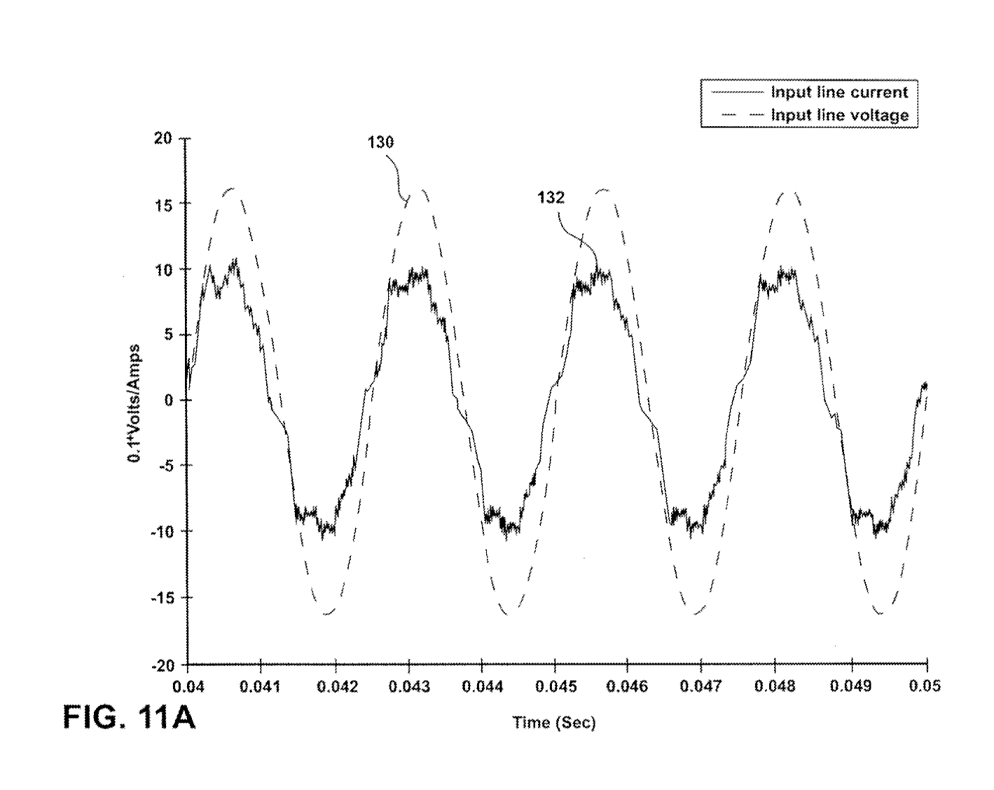

FIG. 10 is a block diagram illustrating an exemplary embodiment of a current limit sub-function 106. In an embodiment, a duty cycle of the boost converter, D_{boost}, may be based on the sign of the Iₑᵣᵣ variable, used by the PWM control sub-function 110 to operate the boost converter. With embodiments, Iₑᵣᵣ can be calculated as the difference between the output current of the boost converter I_{boost} (shown in FIG. 6) and a selected current limit Iₗᵢₘᵢₜ (also shown in FIG. 6). Thus, at a query block 124, a sub-function 106 can determine whether Iₑᵣᵣ is greater than zero (0)—i.e., whether the actual boost converter output current I_{boost} is greater than the selected current limit Iₗᵢₘᵢₜ. If so, then D_{boost} can be set equal to zero at block 126. If Iₑᵣᵣ is zero or negative, then D_{boost} can be set to the duty variable at block 128, the calculation of which is shown in FIG. 6. The current limit sub-function 106 can, for embodiments, be applied to limit the value of D_{boost} to a predetermined design maximum value.

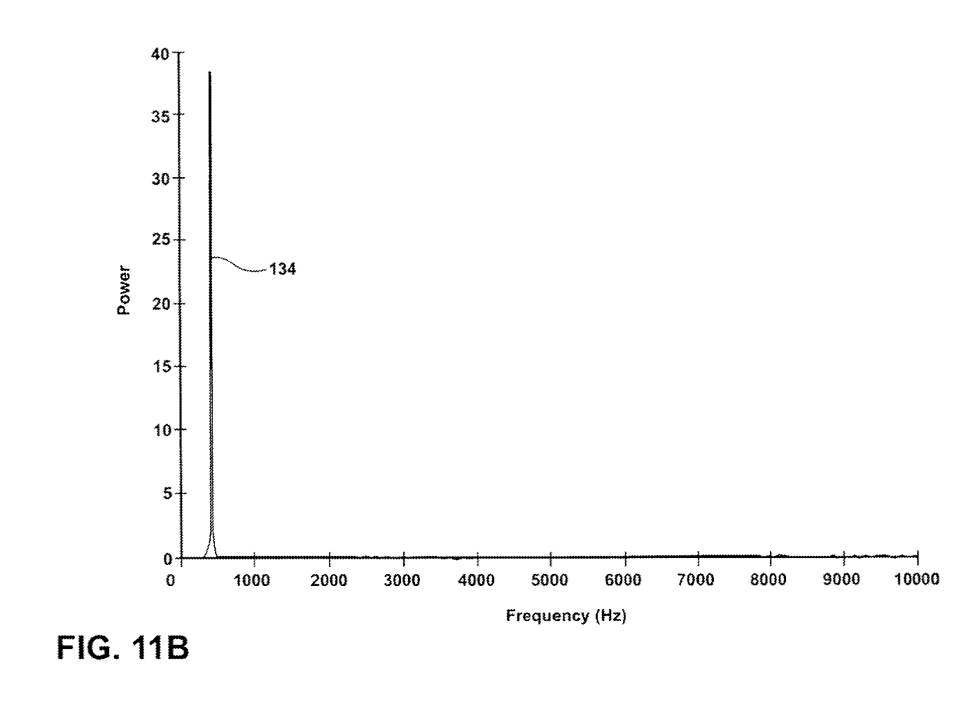

FIGS. 11A-11B are plots illustrating an exemplary input voltage 130, input current 132, and input harmonic content of an AC-DC boost rectifier incorporating power factor correction functionality as generally described above. The input voltage 130 and current 132 may be in phase, though the current 132 may be slightly shifted from the voltage 130, for instance, due to an EMC filter. Further, the primary frequency 134 of the input signal may have a high amplitude, with no significant harmonic components. Thus, as generally shown and described, application of power factor correction as described herein can reduce undesirable input harmonics in a power distribution system.

As the number of electric actuators and other devices in aircraft increases, so too does the electrical load of the aircraft. As the load size increases, higher power converters and power factor correction units are needed. Such high power converters and power factor correction units can be difficult or challenging to design due to limitations of thermal design and the sizing of switching devices. One way to overcome such limitations is through a distributed modular architecture for power factor correction.

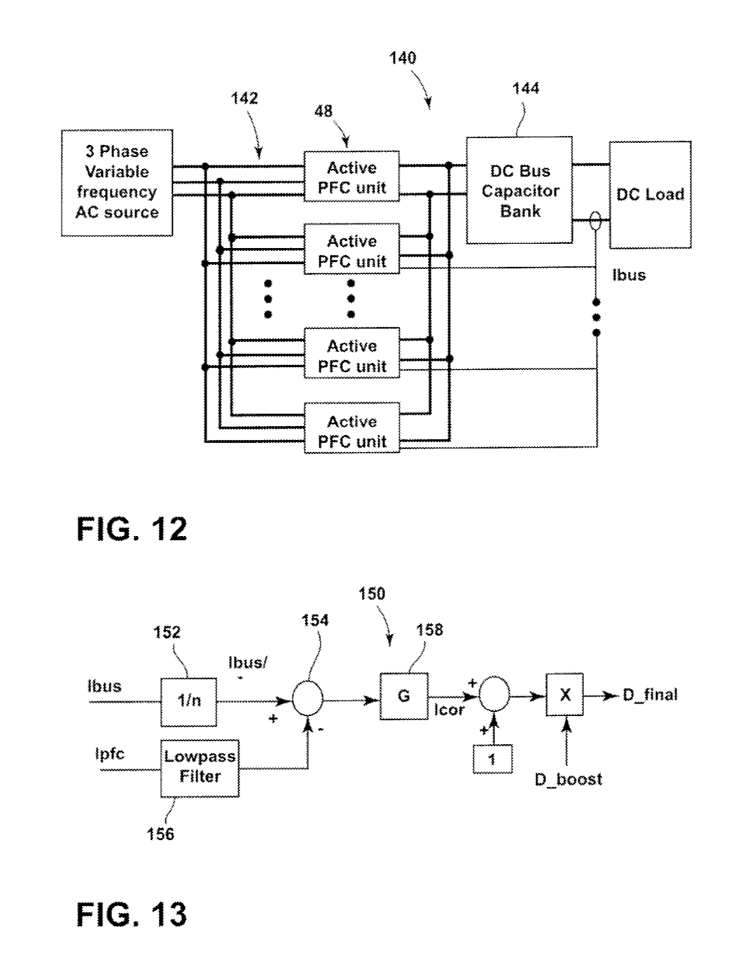

FIG. 12 is a schematic view of an embodiment of a modular distributed power factor correction system 140. The system 140 can include a number of PFC units 48 that may be electrically connected in parallel. The input of the units 48 can, for example, be connected to a common three phase variable or constant frequency AC input power bus 142 and the output can be connected to a common DC bus capacitor bank 144. With embodiments, a system 140 can manage load sharing between the PFC units 48 by regulating the current from each PFC 48. In an embodiment, the boost duty cycle (D_{boost}) of each PFC unit 48 can be modified to regulate the current sharing between different PFC units 48. Control of the parallel units can be shifted in phase to reduce the ripple current at the EMC filter output. The shift may depend on the number of parallel units—for example, for 2 units in parallel the phase of the PWM signal can be offset by 180 degrees between the two units.

FIG. 13 is a block diagram illustrating an embodiment of a current-sharing algorithm 150 that can be executed by each PFC unit 48 in a modular distributed system. Such an algorithm 150 may, for example, be used to determine a boost converter duty cycle D_{boost} for a PFC unit. Each of the units may provide 1/n of the total DC bus current, where n is the number of active PFC units in the system. This current division can be achieved by measuring the DC bus current I_{bus} feeding back into each PFC unit. The DC bus current I_{bus} can be divided by n at a division block 152 and compared to the current output from each PFC unit I_{pfc} at a comparison block 154. Each PFC output current I_{pfc} can be filtered (e.g., lowpass filtered) at a filter block 156 before comparison with the DC bus current I_{bus}. The time constant of the filter can be matched with the DC bus time constant. The difference between I_{bus} and I_{pfc} can be input into a function G at a function block 158. The function G can be a proportional-integral (PI) or PID control algorithm. The current error with the control function G is used to find the correction factor, I_{cor}. Other known control methods may also be used to regulate the current in each module. The boost switch duty cycle, D_{boost}, can then be multiplied by (1+I_{cor}) at a multiplication block 160 to get the final duty cycle D_{final} of an individual boost converter.

The foregoing descriptions of specific embodiments of the present invention have been presented for purposes of illustration and description. They are not intended to be exhaustive or to limit the invention to the precise forms disclosed, and various modifications and variations are possible in light of the above teaching. The embodiments were chosen and described in order to explain the principles of the invention and its practical application, to thereby enable others skilled in the art to utilize the invention and various embodiments with various modifications as are suited to the particular use contemplated. It is intended that the scope of the invention be defined by the claims and their equivalents.

What is claimed:

1. A power factor correction unit, comprising:
an alternating current (AC) input, configured to receive AC electricity;
a rectifier having an input electrically coupled with the AC input and providing a direct current (DC) output;
a power converter having an input electrically coupled with the DC output of the rectifier; and
a power factor control circuit configured to control the power factor of said power factor correction unit, the power factor control circuit configured to output a control signal for the power converter, the control signal produced according to a harmonic of the DC output of the rectifier.

2. The power factor correction unit of claim 1, wherein the harmonic comprises the sixth harmonic of the DC output of the rectifier.

3. The power converter of claim 1, wherein the power converter is a DC-DC converter.

4. The power factor correction unit of claim 3, wherein the power converter is a boost converter.

5. The power factor correction unit of claim 4, wherein the power factor control circuit is configured to generate the control signal to operate the boost converter in a discontinuous conduction mode.

6. The power factor correction unit of claim 1, wherein the control signal comprises a pulse-width modulation control signal.

7. The power factor correction unit of claim 1, wherein the rectifier comprises a three-phase bridge rectifier.

8. The power factor correction unit of claim 1, wherein the power factor control circuit is configured to output the control signal to cause the power converter to output a DC voltage that is twenty-five percent or more above a nominal voltage of the power factor correction unit, the nominal voltage determined according to the AC input.

9. The power factor correction unit of claim 1, further comprising a voltage sensor configured to measure an input voltage of the rectifier and to provide the measured input voltage to the power factor control circuit.

10. A power distribution system for an aircraft, comprising:
an alternating current (AC) input, configured to receive AC electricity;
two or more power factor correction units, each power factor correction unit comprising:
a rectifier having an input electrically coupled with the AC input and providing a direct current (DC) output;
a power converter having an input electrically coupled with the DC output of the rectifier;
a power factor control circuit configured to control the power factor of said power factor correction unit, the power factor control circuit configured to output a control signal for the power converter, the control signal produced according to a harmonic of the DC output of the rectifier;
wherein the two or more power factor correction units are collectively configured to provide a collective DC output.

11. The power distribution system of claim 10, wherein the two or more power factor correction units are connected in parallel between the AC input and the collective DC output.

12. The power distribution system of claim 10, further comprising a capacitor bank electrically coupled with the collective DC output.

13. The power distribution system of claim 10, wherein the power converter of each of the two or more power factor correction units has a respective duty cycle, further wherein the respective duty cycles are offset in phase relative to each other.

14. The power distribution system of claim 13, wherein the phase offset between a first of the power converters and a second of the power converters is determined according to the number of power factor correction units comprising the two or more power factor correction units.

15. A method of distributing power, comprising:
receiving an alternating current (AC) input;
converting the AC input to a direct current (DC) signal with a rectifier;
creating a DC output according to the DC signal with a power converter; and
controlling the power converter with a power factor control circuit according to a harmonic of the DC signal.

16. The method of claim 15, wherein the controlling comprises providing a pulse-width modulation signal for the power converter.

17. The method of claim 15, wherein the controlling comprises operating the power converter in a discontinuous conduction mode.

18. The method of claim 15, wherein the DC output is twenty-five percent or more above a nominal voltage determined according to the AC input.

19. The method of claim 15, further comprising receiving a desired voltage for the DC output, wherein the controlling is further according to the desired voltage.

20. The method of claim 15, wherein the AC input is received from a sensor electrically coupled with an input of the rectifier.
